(19) United States
(12) Patent Application Publication
(10) Pub. No.: US 2025/0283291 A1
(43) Pub. Date: Sep. 11, 2025

(54) TUNED DAMPING METHOD FOR SEISMIC ISOLATION OF PILE FOUNDATIONS IN DEEP-WATER LONG-SPAN CONTINUOUS RIGID FRAME BRIDGE

(71) Applicant: Southwest Jiaotong University, Chengdu City (CN)

(72) Inventors: Canhui ZHAO, Chengdu City (CN); Xiaocong YUAN, Chengdu City (CN); Ruipeng WANG, Chengdu City (CN); Yongtao ZHOU, Chengdu City (CN); Shizhou XIAO, Chengdu City (CN); Kailai DENG, Chengdu City (CN); Zehong DU, Chengdu City (CN); Yi Chen, Chengdu City (CN); Yexin ZHANG, Chengdu City (CN)

(73) Assignee: Southwest Jiaotong University, Chengdu City (CN)

(21) Appl. No.: 19/071,653

(22) Filed: Mar. 5, 2025

(30) Foreign Application Priority Data
Mar. 5, 2024 (CN) 202410251655.X

(51) Int. Cl. E02D 31/08; G06F 30/13

(52) U.S. Cl. CPC E02D 31/08; G06F 30/13

(57) ABSTRACT

Some embodiments of the disclosure disclose a tuned damping method for seismic isolation of pile foundations in a deep-water long-span continuous rigid frame bridge, which relates to the technical field of shock absorption for bridge engineering structures. It solves the problem that the “pile foundation seismic isolation” of deep-water long-span continuous rigid frame bridges lacks a theoretical quantitative calculation method, making it impossible to fully exert the effect of “pile foundation isolation”. The present disclosure includes: simplifying a deep-water long-span continuous rigid frame bridge model into a 2-degree-of-freedom dynamical model; setting an optimization objective function based on the 2-degree-of-freedom dynamical model; performing parameter optimization based on the optimization objective function; and determining structural seismic parameters of the deep-water long-span continuous rigid frame bridge based on parameters optimized in step 3.

### TECHNICAL FILED

The present disclosure relates to the field of seismic damping technology for bridge engineering structures, and specifically relates to a tuned damping method for seismic isolation of pile foundations in a deep-water long-span continuous rigid frame bridge.

### BACKGROUND

Seismic isolation design achieves the goal of reducing the internal force response of structures by pre-installing seismic isolation elements and prolonging the structural period. It is an important technical approach in the seismic design of bridges. In conventional seismic isolation design, bearings are commonly used as seismic isolation elements. In deep-water long-span continuous rigid frame bridges, it is inconvenient to use seismic isolation bearings to achieve seismic isolation due to the fixed connection between a main pier and a main girder. However, the deep-water long-span continuous rigid frame bridges typically use high-pile caps with relatively long unrestrained pile lengths and relatively weak lateral stiffness of pile foundations, which can prolong the natural vibration period of the structure, thereby forming “pile foundation seismic isolation”.

The engineering community has recognized the seismic isolation effect of pile foundations. Through the proper matching of superstructure mass-bridge pier stiffness-pile cap mass-pile foundation stiffness, more seismic energy can be converted into structural kinetic energy, further enhancing the “pile foundation seismic isolation” effect. However, the discussion on this effect remains at a qualitative level. There remains a lack of theoretical research and quantitative calculation methods to effectively utilize the beneficial effect, optimize the structural design, and fully exploit the seismic isolation effect of pile foundations.

### SUMMARY

To solve the problems in the art known to inventors mentioned above, the present disclosure provides a tuned damping method for seismic isolation of pile foundations in a deep-water long-span continuous rigid frame bridge to solve the problem of the lack of theoretical quantitative calculation methods for “pile foundation seismic isolation” in deep-water long-span continuous rigid frame bridges.

A tuned damping method for seismic isolation of pile foundations in a deep-water long-span continuous rigid frame bridge, including the following steps:
step 1: simplifying a deep-water long-span continuous rigid frame bridge model into a 2-degree-of-freedom dynamical model;
step 2: constructing an optimization objective function based on the 2-degree-of-freedom dynamical model;
step 3: performing parameter optimization based on the optimization objective function to obtain an optimal frequency ratio f, and based on the optimal frequency ratio f to calculate corrected pile foundation stiffness k_{β1};
step 4: calculating corrected equivalent moments of inertia I₄₁ and I₅₁ for a pile foundation based on the corrected pile foundation stiffness k_{β1}, and inferring a corresponding pile foundation layout and an optimal diameter based on the corrected equivalent moments of inertia I₄₁ and I₅₁.

In some embodiments, the step 1 includes:
step 1.1: simplifying the deep-water long-span continuous rigid frame bridge model into a 3-degree-of-freedom dynamical model;
step 1.2: simplifying the 3-degree-of-freedom dynamical model into the 2-degree-of-freedom dynamical model.

In some embodiments, the step 1.1 includes:
letting anti-thrust stiffness of a pile group in the deep-water long-span continuous rigid frame bridge model be kₚ, and solving by means of a displacement method or finite element simulation method to obtain an equivalent moment of inertia Iₚ:

$${I}_{p} = \frac{{k}_{p} {L}_{p}^{3}}{12 {E}_{p}} \qquad ( 1 )$$

where, Lₚ is a pile foundation length, and Eₚ is the elastic modulus of pile foundation;
basing on the equivalent moment of inertia Iₚ to simplify the deep-water long-span continuous rigid frame bridge model into the 3-degree-of-freedom dynamical model, with parameters comprising the pier column stiffness, the pile foundation stiffness, and the mass parameters, and specific formulas for the parameters are as follows:

The pier column stiffness comprises a pier column longitudinal stiffness k₂ and a pier column transverse stiffness k₃:

$${k}_{2} = \frac{3 {E}_{2} {I}_{2}}{{L}_{2}^{3}} + Δ k \\ {k}_{3} = \frac{3 {E}_{3} {I}_{3}}{{L}_{3}^{3}} + Δ k \qquad ( 2 )$$

The pile foundation stiffness comprises a pile foundation longitudinal stiffness k₄ and a pile foundation transverse stiffness k₅, which can be calculated using a force method or a finite element method;

### Main Girder Bending Restraint Correction Term:

$$Δ k = \frac{6 {E}_{2} {I}_{2} ( 6 {E}_{1} {I}_{1} {L}_{2} + {E}_{2} {I}_{2} {L}_{1} )}{{L}_{2}^{3} ( 3 {E}_{1} {I}_{1} {L}_{2} + 2 {E}_{2} {I}_{2} {L}_{1} )} - \frac{3 {E}_{2} {I}_{2}}{{L}^{3}} \qquad ( 3 )$$

the mass parameters comprises a pier top mass and a pier bottom mass:

### The Pier Top Mass:

$${m}_{1} = \frac{{m}_{b}}{2} + \frac{{m}_{p 2}}{2} \\ {m}_{2} = \frac{{m}_{b}}{2} + \frac{{m}_{p 3}}{2} \qquad ( 4 )$$

### The Pier Bottom Mass:

$${m}_{3} = \frac{{m}_{c}}{2} + \frac{{m}_{p 2}}{2} + \frac{{m}_{p 4}}{2} \\ {m}_{4} = \frac{{m}_{c}}{2} + \frac{{m}_{p 3}}{2} + \frac{{m}_{p 5}}{2} \qquad ( 5 )$$

where, I₂ and I₃ are moments of inertia of cross-sections of pier columns, I₄ and I₅ are calculated according to equation (1), m₁ is the sum of main girder mass and pier column mass on a left span of a bridge, m₂ is the sum of main girder mass and pier column mass on a right span of the bridge, m₃ is the sum of pier column mass and pile foundation mass on the left span of the bridge, m₄ is the sum of pier column mass and pile foundation mass on the right span of the bridge, m_{b} is the total mass of a main girder, mₚ₂ and mₚ₃ are masses of bridge piers respectively, mₚ₄ and mₚ₅ are masses of pile foundations respectively, L₁ is the length of the main girder, L₂ and L₃ are the lengths of the bridge piers, L₄ and L₅ are the lengths of the pile foundations, E₁ is the elastic modulus of the main girder, E₂ and E₃ are the elastic modulus of the bridge piers, and L₄ and L₅ are the elastic modulus of the pile foundations;
a mass matrix M and a stiffness matrix K of the 3-degree-of-freedom dynamical model are:

$$\begin{matrix}M = [ \begin{matrix}{m}_{1} + {m}_{2} & 0 & 0 \\ 0 & {m}_{3} & 0 \\ 0 & 0 & {m}_{4}\end{matrix} ] & ( 6 ) \\ K = [ \begin{matrix}{k}_{2} + {k}_{3} + 2 Δ k & - {k}_{2} - Δ k & - {k}_{3} - Δ k \\ - {k}_{2} - Δ k & {k}_{4} + {k}_{2} + Δ k & 0 \\ - {k}_{3} - Δ k & 0 & {k}_{5} + {k}_{3} + Δ k\end{matrix} ] & ( 7 )\end{matrix}$$

In some embodiments, the step 1.2 includes: assuming the deep-water long-span continuous rigid frame bridge model to be a symmetric structure, that is: E₂I₂=E₃I₃, E₄I₄=E₅I₅, m₁=m₂, m₃=m₄, L₂=L₃, and L₄=L₅, and further simplifying the 3-degree-of-freedom dynamical model into the 2-degree-of-freedom dynamical model, with the mass matrix M and stiffness matrix K thereof as shown in equations (8) and (9) respectively:

$$\begin{matrix}M = [ \begin{matrix}{M}_{α} & 0 \\ 0 & {M}_{β}\end{matrix} ] & ( 8 ) \\ K = [ \begin{matrix}{k}_{α} & - {k}_{α} \\ - {k}_{α} & {k}_{α} + {k}_{β}\end{matrix} ] & ( 9 )\end{matrix}$$

where,

$$\begin{matrix}{L}_{α} = \frac{{L}_{2} + {L}_{3}}{2} , {L}_{β} = \frac{{L}_{4} + {L}_{5}}{2} & ( 10 ) \\ {M}_{α} = {m}_{1} + {m}_{2} , {M}_{β} = {m}_{3} + {m}_{4} & ( 11 ) \\ {k}_{α} = 4 ( {k}_{2} + {k}_{3} ) & ( 12 ) \\ {k}_{β} = {k}_{4} + {k}_{5} & ( 13 )\end{matrix}$$

where, k_{α} is the total stiffness of a 2-degree-of-freedom pier column integration, and k_{β} is the total stiffness of the 2-degree-of-freedom pile foundation integration.

In some embodiments, the step 2 includes:
step 2.1: constructing motion equations for a 2-degree-of-freedom system based on the 2-degree-of-freedom dynamical model;
Step 2.2: constructing an optimization objective function based on the motion equations for the 2-degree-of-freedom system.

In some embodiments, the step 2.1 includes: considering damping of the bridge piers and the pile foundations, and enabling the bridge structure to undergo random vibration under the action of P(t), wherein y₁ and y₂ represent 2-degree-of-freedom displacement time history functions relative to a foundation, and motion equations for the 2-degree-of-freedom dynamical model can be obtained by means of a direct equilibrium method as follows:

$${m}_{α} {\ddot{y}}_{α} + {c}_{α} ( {\dot{y}}_{α} - {\dot{y}}_{β} ) + {k}_{α} ( {y}_{α} - {y}_{β} ) = P ( t ) \\ {m}_{β} {\ddot{y}}_{β} + {c}_{β} {\dot{y}}_{β} + {c}_{α} ( {\dot{y}}_{β} - {\dot{y}}_{α} ) + {k}_{β} {y}_{β} + {k}_{α} ( {y}_{β} - {y}_{α} ) = 0 \qquad ( 14 )$$

where cᵢ is the damping coefficient; yᵢ is the relative displacement of the mass point; \dot{u}ᵢ is the relative velocity of the mass point; ÿᵢ is the relative acceleration of the mass point; P(t) is an inertial force caused by ground motion, and P(t) is a random excitation which can be decomposed into the superposition of a series of harmonic components as follows:

$$P ( t ) = {\int }_{- ∞}^{∞} {p}_{0} {e}^{i θ t} d θ \qquad ( 15 )$$

for any frequency component θ, P^{(θ)}(t)=p₀e^{iθt} is a harmonic excitation, and resulting displacements y₁⁽⁶⁾ (t) and y₂^{(θ)}(t) are also harmonic variables and can be expressed as follows:

$${y}_{1}^{( θ )} ( t ) = {Y}_{1} {e}^{i θ t} , {y}_{2}^{( θ )} ( t ) = {Y}_{2} {e}^{i θ t} \qquad ( 16 )$$

substituting P^{(θ)}(t) and equation (16) into equation (14) to obtain

$$- {m}_{α} {θ}^{2} {Y}_{1} + {c}_{α} i θ ( {Y}_{1} - {Y}_{2} ) + {k}_{α} ( {Y}_{1} - {Y}_{2} ) = {p}_{0} \\ - {m}_{β} {θ}^{2} {Y}_{2} + {c}_{β} i θ {Y}_{2} + {c}_{α} i θ ( {Y}_{2} - {Y}_{1} ) + {k}_{β} {Y}_{β} + {k}_{α} ( {Y}_{2} - {Y}_{1} ) = 0 \qquad ( 17 )$$

solving to obtain amplitudes of y₁(t) and y₂(t):

$$\begin{matrix}{Y}_{1} = \frac{- {p}_{0} ( {k}_{α} + {k}_{β} - {m}_{β} {θ}^{2} + {c}_{α} θ i + {c}_{β} θ i )}{\begin{matrix}{k}_{α} {m}_{α} {θ}^{2} - {k}_{α} {k}_{β} + {k}_{α} {m}_{β} {θ}^{2} + {k}_{β} {m}_{α} {θ}^{2} + {c}_{α} {c}_{β} {θ}^{2} - {m}_{α} {m}_{β} {θ}^{4} - \\ {k}_{β} {c}_{α} θ i - {k}_{α} {c}_{β} θ i + {m}_{α} {c}_{α} {θ}^{3} i + {m}_{β} {c}_{α} {θ}^{3} i + {m}_{α} {c}_{β} {θ}^{3} i\end{matrix}} & ( 18 ) \\ {Y}_{2} = \frac{- {p}_{0} ( {k}_{α} + {c}_{α} θ i )}{\begin{matrix}{k}_{α} {m}_{α} {θ}^{2} - {k}_{α} {k}_{β} + {k}_{α} {m}_{β} {θ}^{2} + {k}_{β} {m}_{α} {θ}^{2} + {c}_{α} {c}_{β} {θ}^{2} - {m}_{α} {m}_{β} {θ}^{4} - \\ {k}_{β} {c}_{α} θ i - {k}_{α} {c}_{β} θ i + {m}_{α} {c}_{α} {θ}^{3} i + {m}_{β} {c}_{α} {θ}^{3} i + {m}_{α} {c}_{β} {θ}^{3} i\end{matrix}} & ( 19 )\end{matrix}$$

substituting into equations (16) to obtain y₁^{(θ)}(t) and y₂^{(θ)}(t), and summing y₁^{(θ)}(t) and y₂^{(θ)}(t) over a frequency domain to obtain y₁(t) and y₂(t).

In some embodiments, the step 2.2 includes: letting a pier bottom bending moment as an indicator to evaluate an overall structural response:

$$M ( t ) = {k}_{α} {L}_{α} ( {y}_{1} ( t ) - {y}_{2} ( t ) ) \qquad ( 20 )$$

for any frequency component θ,

$${M}^{( θ )} ( t ) = {k}_{α} {L}_{α} ( {y}_{1}^{( θ )} ( t ) - {y}_{2}^{( θ )} ( t ) ) \qquad ( 21 )$$

substituting equations (18) and (19) into equation (21) to obtain M^{(θ)}(t), and expressing M^{(θ)}(t) in the form of a transfer function H(θ) as follows:

$$M ( t ) = {\int }_{- ∞}^{∞} H ( θ ) {P}_{0} {e}^{i θ t} d θ \qquad ( 22 )$$

where,

$$H ( θ ) = {k}_{α} {L}_{α} \frac{{k}_{β} - {m}_{β} {θ}^{2} + {ic}_{β} θ}{\begin{matrix}\begin{matrix}- {k}_{α} {m}_{α} {θ}^{2} + {k}_{α} {k}_{β} - {k}_{α} {m}_{β} {θ}^{2} - \\ {k}_{β} {m}_{α} {θ}^{2} - {c}_{α} {c}_{β} {θ}^{2} + {m}_{α} {m}_{β} {θ}^{4} +\end{matrix} \\ i ( {k}_{β} {c}_{α} θ + {k}_{α} {c}_{β} θ - {m}_{α} {c}_{α} {θ}^{3} - {m}_{α} {c}_{β} {θ}^{3} )\end{matrix}} \qquad ( 23 )$$

when a variance σₘ² of M(t) is minimized, M(t) is also minimized, and let the variance σₘ² be:

$${σ}_{m}^{2} = E [ {\vert M ( t ) \vert}^{2} ] \qquad ( 24 )$$

substituting equation (23) into equation (24) and performing non-dimensionalization to obtain a non-dimensional form I of the variance σₘ²:

$$I = \frac{1}{2 π} {\int }_{- ∞}^{∞} {\vert H ( g ) \vert}^{2} d g \qquad ( 25 )$$

where, g represents a ratio

$$( \frac{θ}{{ω}_{α}} )$$

of a seismic excitation to a structural frequency; and H(g) is the non-dimensional form of the transfer function H(θ):

$$H ( g ) = \frac{( {f}^{2} - {g}^{2} ) + 2 i \frac{{c}_{β}}{{c}_{c β}} gf}{\begin{matrix}( - \frac{1}{μ} {g}^{2} + ( {g}^{2} - {f}^{2} ) ( {g}^{2} - 1 ) + \frac{4 {c}_{α} {c}_{β}}{{c}_{c α} {c}_{c β}} {fg}^{2} ) + \\ i ( 2 \frac{{c}_{α}}{{c}_{c α}} g ( {f}^{2} - \frac{1}{μ} {g}^{2} - {g}^{2} ) + 2 \frac{{c}_{β}}{{c}_{c β}} fg ( 1 - {g}^{2} ) )\end{matrix}} \qquad ( 26 )$$

where,

$$μ = \frac{{m}_{β}}{{m}_{α}} {ω}_{α}^{2} = \frac{{k}_{α}}{{m}_{α}} {ω}_{β}^{2} = \frac{{k}_{β}}{{m}_{β}} f = \frac{{ω}_{β}}{{ω}_{α} } \\ g = \frac{θ }{{ω}_{α}} {c}_{c α} = 2 {m}_{α} {ω}_{β} {c}_{c β} = 2 {m}_{β} {ω}_{β} \frac{{k}_{β}}{{k}_{α}} = μ {f}^{2} \qquad ( 27 )$$

In equation (26), μ represents a mass ratio of a pile cap to a main girder equivalent mass point, ω_{α} represents a natural vibration frequency of the main girder and the bridge pier, ω_{β} represents a natural vibration frequency of the pile cap and the pile foundation, f represents a frequency ratio between the pile foundation and the pier column, g represents a frequency ratio between an external load excitation and the pier column, c_{cα} represents critical damping of the bridge pier, and c_{cβ} represents critical damping of the pile foundation;

equation (25) is organized as:

$$H ( g ) = \frac{{B}_{0} + {igB}_{1} - {g}^{2} {B}_{2}}{{A}_{0} + {igA}_{1} - {g}^{2} {A}_{2} - {ig}^{3} {A}_{3} + {g}^{4} {A}_{4}} \qquad ( 28 )$$

where,

$${B}_{0} = {f}^{2} ; {B}_{1} = 2 \frac{{c}_{β}}{{c}_{c β}} f ; {B}_{2} = 1 ; {A}_{0} = {f}^{2} ; {A}_{1} = 2 \frac{{c}_{α}}{{c}_{c α}} {f}^{2} + 2 \frac{{c}_{β}}{{c}_{c β}} f \\ {A}_{2} = \frac{1}{μ} + {f}^{2} + 1 - \frac{4 {c}_{{α}^{C} β}}{{c}_{c α} {c}_{c β}} f ; {A}_{3} = 2 \frac{1}{μ} \frac{{c}_{α}}{{c}_{c α}} + 2 \frac{{c}_{α}}{{c}_{c α}} + 2 \frac{c β}{{c}_{c β}} f ; {A}_{4} = 1 \qquad ( 29 )$$

equation (28) is substituted into equation (25) and then integrated and let

$${ξ}_{1} = \frac{{c}_{1}}{{c}_{c α}} and {ξ}_{2} = \frac{{c}_{2}}{{c}_{c} β} ,$$

the non-dimensional form I of the variance σ² can be obtained, which is the optimization objective function:

$$\begin{matrix}I = \frac{[ \begin{matrix}- {A}_{0} {A}_{1} {A}_{4} {B}_{2}^{2} - {A}_{0} {A}_{3} {A}_{4} ( {B}_{1}^{4} - 2 {B}_{0} {B}_{2} ) + \\ {A}_{4} {B}_{0}^{2} ( {A}_{1} {A}_{4} - {A}_{2} {A}_{3} )\end{matrix} ]}{2 {A}_{0} {A}_{4} ( {A}_{0} {A}_{3}^{2} + {A}_{1}^{2} {A}_{4} - {A}_{1} {A}_{2} {A}_{3} )} \\ = \frac{M ( μ , f , {ξ}_{1} , {ξ}_{2} )}{N ( μ , f , {ξ}_{1} , {ξ}_{2} )}\end{matrix} \qquad ( 30 )$$

In some embodiments, the step 3 includes: optimizing the variance by means of an enumeration method, determining an optimal frequency ratio f corresponding to each mass ratio μ when the variance is minimized, and performing curve fitting to obtain an explicit expression for the optimal frequency ratio f:

$$f = 1.108 {e}^{- 0.027 \; 55 μ} - 1.116 {e}^{- 0.436 \; 8 μ} \qquad ( 31 )$$

based on the optimal frequency ratio f, calculating a total stiffness correction value k_{β1} of a 2-degree-of-freedom pile foundation integration:

$${k}_{β 1} = \frac{{m}_{β} {k}_{α} {f}^{2}}{{m}_{α}} \qquad ( 32 )$$

In some embodiments, the optimization process using the enumeration method includes the following steps:
(1) determining the mass ratio μᵢ;
(2) traversing the frequency ratio f;
(3) calculating the variance I(f, μ);
(4) minimizing the variance I;
(5) obtaining the corresponding I(fᵢ, μᵢ);
(6) updating μᵢ=μᵢ+Δμ; and simultaneously obtaining the relationship f(u) between the optimal frequency ratio and the mass ratio.

In some embodiments, the step 4 includes:
calculating the mass ratio μ according to equation (27), substituting the mass ratio μ into equation (31) to obtain an optimal frequency ratio f of the pile foundation, according to equation (32) to obtain the total stiffness correction value k_{β1} for the 2-degree-of-freedom pile foundation integration, calculating corrected bridge pier and pile foundation stiffness k₄₁ and k₅₁, back-calculating the equivalent moments of inertia I₄₁ and I₅₁ of the pile foundation according to equation (1), and based on the equivalent moments of inertia I₄₁ and I₅₁, inferring the corresponding pile foundation layout and the optimal diameter, where calculation formulas for k₄₁ and k₅₁ are as follows:

$${k}_{41} = \frac{{k}_{β 1} {k}_{4}}{{k}_{β}} \qquad ( 33 )$$

$${k}_{51} = \frac{{k}_{β 1} {k}_{5}}{{k}_{β}}$$

The beneficial effects of the present disclosure are as follows:

Based on the fundamental principle of tuned damping, the present disclosure proposes a reasonable calculation method for the pile foundation-pile cap-pier column design parameters, thereby improving the damping efficiency of a pile foundation seismic isolation system. By adopting an optimized pile foundation diameter determined through random excitation optimization, the responses of the pier columns, pile foundations, and main girders are significantly reduced, effectively controlling the seismic response of the continuous rigid frame bridges. The determination method for design parameters of pile foundations and bridge piers is shifted from relying on experience to utilizing structural dynamics calculations, which results in more accurate parameters and faster parameter determination, significantly shortening the design time and lowering design costs.

### BRIEF DESCRIPTION OF THE DRAWINGS

FIG. 1 illustrates a mechanical model of a tuned mass damper according to Embodiment 1.

FIG. 2 illustrates a high-pile cap continuous rigid frame bridge and an equivalent model thereof according to Embodiment 1.

FIG. 3 (a) illustrates a pile group foundation being simplified to a one-dimensional structure according to Embodiment 1.

FIG. 3 (b) illustrates a simplified planar model of the pile group foundation according to Embodiment 1.

FIG. 4 illustrates a 3-degree-of-freedom simplified model for a continuous rigid frame bridge according to Embodiment 1.

FIG. 5 illustrates a 2-degree-of-freedom simplified model for a continuous rigid frame bridge according to Embodiment 1.

FIG. 6 illustrates a 2-degree-of-freedom system model according to Embodiment 1.

FIG. 7 illustrates a I(f, μ) three-dimensional diagram according to Embodiment 1.

FIG. 8 illustrates a flowchart of calculating an optimal frequency ratio according to Embodiment 1.

FIG. 9 illustrates a graph of the optimal frequency ratio according to Embodiment 1.

FIG. 10 illustrates a flow diagram of a tuned damping method for seismic isolation of pile foundations in a deep-water long-span continuous rigid frame bridge.

### DETAILED DESCRIPTION OF THE EMBODIMENTS

In order to make the objectives, technical solutions and advantages of embodiments of the present application clearer, the technical solutions in the embodiments of the present application will be described clearly and completely below with reference to the accompanying drawings in the embodiments of the present application. Apparently, the embodiments described are some of, rather than all of, the embodiments of the present application. Thus, the following detailed description of the embodiments of the present disclosure, as represented in the drawings, is not intended to limit the scope of the present application as claimed, but is merely representative of the selected embodiments of the present application. Based on the embodiments of the present application, all other embodiments obtained by those of ordinary skill in the art without creative work fall within the scope of protection of the present application.

### Embodiment 1

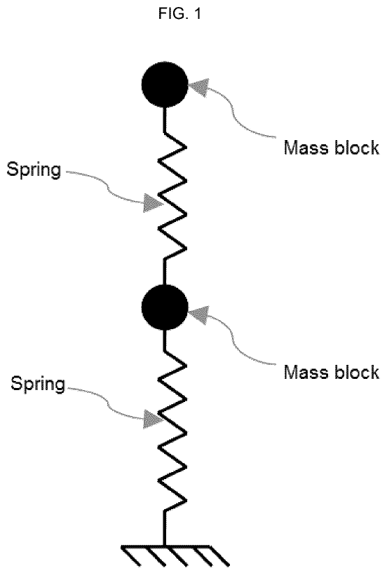

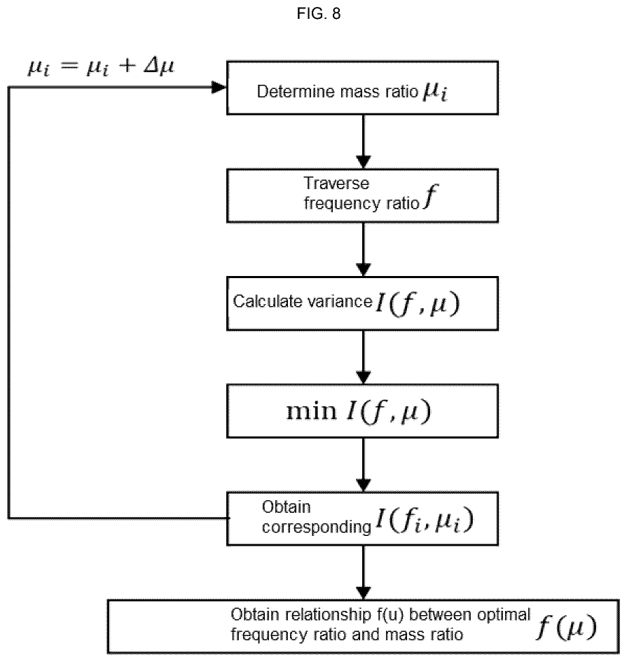

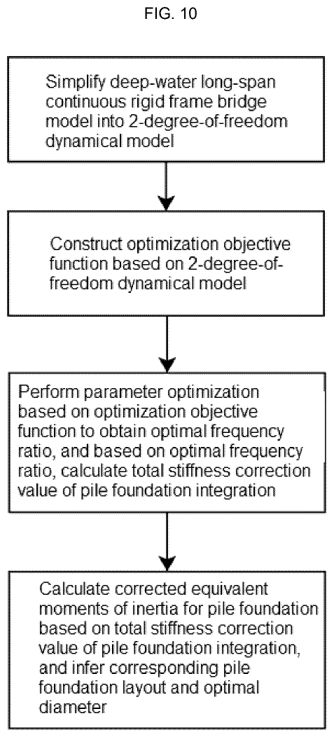

A specific embodiment of the present disclosure will be described below in conjunction with FIGS. 1 to 10.

A core component for mass-tuned damping is a tuned mass damper (TMD), and a mechanical model thereof is composed of mass blocks, a damper, and springs, as shown in FIG. 1. When the TMD is added to an original system, the original system vibrates under dynamic loads, and the TMD generates an opposing force to counteract the vibration of the original system, thereby reducing the dynamic response.

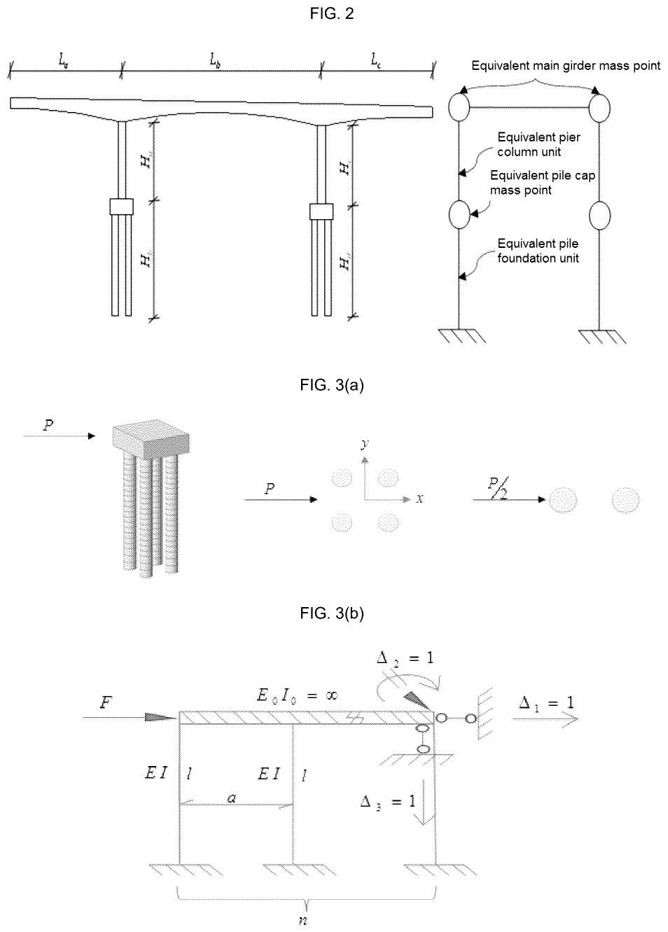

For a deep-water long-span continuous rigid frame bridge, the mass is mainly distributed in a main girder and a pile cap. The mass of the pile cap can be regarded as the first mass M1, and the mass of the main girder can be regarded as the second mass M2. An unrestrained pile foundation in water can be regarded as a first spring K1, and a bridge pier can be regarded as a second spring K2. Therefore, a high-pile cap continuous rigid frame bridge can be equivalent to a TMD system, as shown in FIG. 2. By applying the principles of mass-tuned damping, a reasonable stiffness ratio between the pile foundation and the bridge pier, as well as a reasonable mass ratio between the main girder and the pile cap, can be sought to reduce the seismic response of the structure. Based on the optimal stiffness or mass ratio, the seismic optimization design of the “pile foundation seismic isolation” system bridge can be guided.

A tuned damping method for seismic isolation of pile foundations in a deep-water long-span continuous rigid frame bridge specifically includes the following steps:
Step 1: simplifying a mechanical model;
step 1.1: simplifying a deep-water long-span continuous rigid frame bridge model into a 3-degree-of-freedom dynamical model;

In a direction perpendicular to seismic wave input, pile foundations are parallel, so the bending stiffness and axial stiffness thereof are the sum of the bending and axial stiffnesses of the pile foundations in the direction perpendicular to the seismic wave input. (as shown in FIG. 3-a). Therefore, a pile foundation structure with a two-dimensional distribution can be simplified into a one-dimensional planar structure. Since the stiffness of a pile cap is much greater than the stiffness of a pile foundation, the pile cap can be considered a rigid body. Thus, a simplified planar model of a pile group foundation is shown in FIG. 3-b.

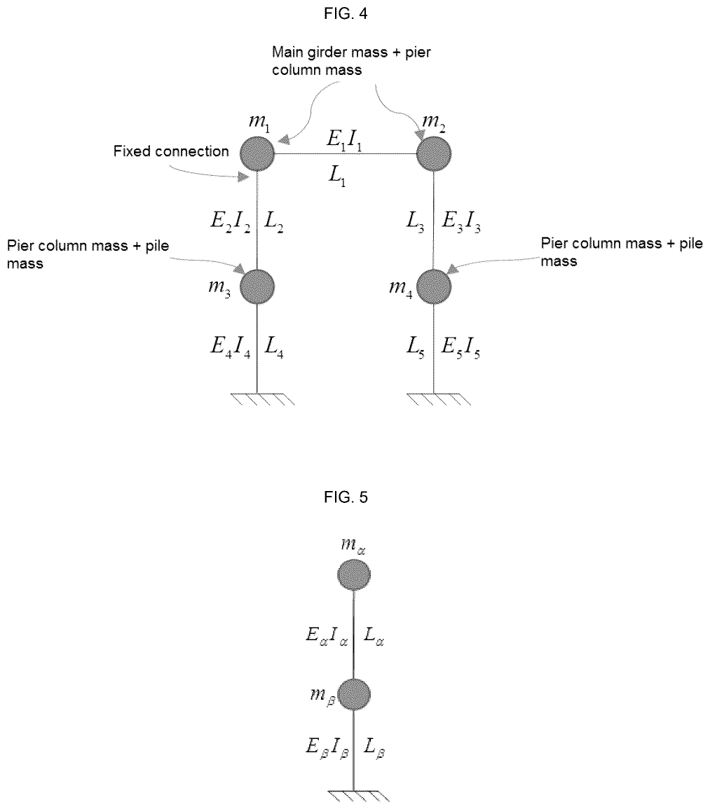

Considering the axial deformation of the pile foundations, there are 3 key displacements. Even with n pile foundations along a seismic wave input direction, the number of basic unknown displacement quantities remains 3. Based on this, the anti-thrust stiffness kₚ of a pile group and the equivalent moment of inertia Iₚ of the pile group can be solved:

$${I}_{p} = \frac{{k}_{p} {L}_{p}^{3}}{12 {E}_{p}} \qquad ( 1 )$$

where, Lₚ and Eₚ represent the pile foundation length and the elastic modulus, respectively; kₚ is the anti-thrust stiffness of the pile group; based on the simplified planar model of the pile group foundation, the simplified mechanical model for the continuous rigid frame bridge is shown in FIG. 4.

Stiffness parameters in the figure include the pier column stiffness, the pile foundation stiffness, and the mass parameters, which are calculated according to formulas of structural dynamics methods as follows:
the pier column stiffness includes a pier column longitudinal stiffness and a pier column transverse stiffness:

$$\begin{matrix}{k}_{2} = \frac{3 {E}_{2} {I}_{2}}{{L}_{2}^{3}} + Δ k & {k}_{3} = \frac{3 {E}_{3} {I}_{3}}{{L}_{3}^{3}} + Δ k\end{matrix} \qquad ( 2 )$$

the pile foundation stiffness comprises pile foundation longitudinal stiffness k₄ and pile foundation transverse stiffness k₅, which can be calculated using a force method or a finite element method;

### Main Girder Bending Restraint Correction Term:

$$Δ k = \frac{6 {E}_{2} {I}_{2} ( 6 {E}_{1} {I}_{1} {L}_{2} + {E}_{2} {I}_{2} {L}_{1} )}{{L}_{2}^{3} ( 3 {E}_{1} {I}_{1} {L}_{2} + 2 {E}_{2} {I}_{2} {L}_{1} )} - \frac{3 {E}_{2} {I}_{2}}{{L}^{3}} \qquad ( 3 )$$

### Pier Top Mass:

$$\begin{matrix}{m}_{1} = \frac{{m}_{b}}{2} + \frac{{m}_{p 2}}{2} & {m}_{2} = \frac{{m}_{b}}{2} + \frac{{m}_{p 3}}{2}\end{matrix} \qquad ( 4 )$$

### Pier Bottom Mass:

$${m}_{3} = \frac{{m}_{c}}{2} + \frac{{m}_{p 2}}{2} + \frac{{m}_{p 4}}{2} \qquad ( 5 )$$

$${m}_{4} = \frac{{m}_{c}}{2} + \frac{{m}_{p 3}}{2} + \frac{{m}_{p 5}}{2}$$

where, I₂ and I₃ are moments of inertia of cross-sections of pier columns, I₄ and I₅ are equivalent moments of inertia of the pile foundations and are calculated according to equation (1), m₁ is the sum of main girder mass and pier column mass on a left span of a bridge, m₂ is the sum of main girder mass and pier column mass on a right span of the bridge, m₃ is the sum of pier column mass and pile foundation mass on the left span of the bridge, m₄ is the sum of pier column mass and pile foundation mass on the right span of the bridge, m_{b} is the total mass of the main girder, mₚ₂ and mₚ₃ are masses of bridge piers, respectively, mₚ₄ and mₚ₅ are masses of pile foundations, L₁ is the length of the main girder, L₂ and L₃ are the lengths of the bridge piers, L₄ and L₅ are the lengths of the pile foundations, E₁ is the elastic modulus of the main girder, E₂ and E₃ are the elastic modulus of the bridge piers, and L₄ and L₅ are the elastic modulus of the pile foundations;

Since axial stiffness of the main girder L₁ is infinite, a 4-mass-point model shown in FIG. 4 is essentially a 3-degree-of-freedom dynamical model. The first degree of freedom corresponds to the horizontal displacement of m₁+m₂, the second degree of freedom corresponds to the horizontal displacement of m₃, and the third degree of freedom corresponds to the horizontal displacement of m₄. A mass matrix M and a stiffness matrix K of the model are:

$$M = [ \begin{matrix}{m}_{1} + {m}_{2} & 0 & 0 \\ 0 & {m}_{3} & 0 \\ 0 & 0 & {m}_{4}\end{matrix} ] \qquad ( 6 )$$

$$K = [ \begin{matrix}{k}_{2} + {k}_{3} + 2 Δ k & − {k}_{2} − Δ k & − {k}_{3} − Δ k \\ − {k}_{2} − Δ k & {k}_{4} + {k}_{2} + Δ k & 0 \\ − {k}_{3} − Δ k & 0 & {k}_{5} + {k}_{3} + Δ k\end{matrix} ] \qquad ( 7 )$$

step 1.2: simplifying the 3-degree-of-freedom dynamical model into a 2-degree-of-freedom dynamical model;

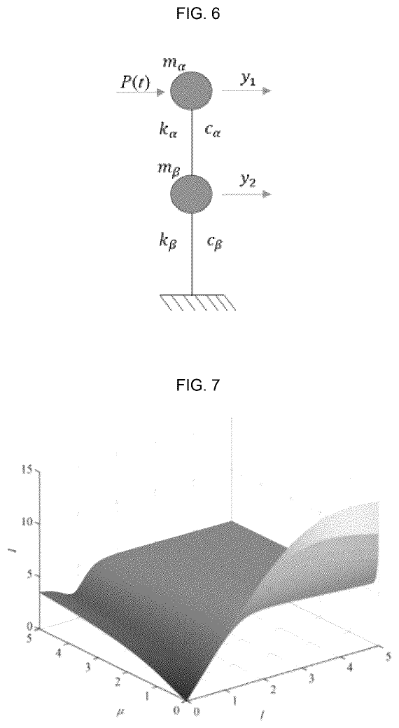

Clearly, in the 3-degree-of-freedom dynamical model shown in FIG. 4, the motion of mass points m₃ and m₄ only occurs in two directions: in the same direction or the opposite directions. When moving in the same direction, an anti-symmetric vibration mode occurs, and when moving in the opposite directions, a symmetric vibration mode occurs. Since longitudinal seismic excitation is anti-symmetric, it only excites the anti-symmetric vibration mode. Therefore, under the longitudinal seismic action, the symmetric vibration mode does not contribute to the structural response. For simplicity in the derivation and from an engineering application perspective, it is assumed that the structure is symmetric, that is: E₂I₂=E₃I₃, E₄I₄=E₅I₅, m₁=m₂, m₃=m₄, L₂=L₃, and L₄=L₅, and the 3-degree-of-freedom dynamical model in FIG. 4 can be further simplified into a 2-degree-of-freedom dynamical model shown in FIG. 5, with the mass matrix M and the stiffness matrix K thereof as shown in equations (8) and (9) respectively:

$$M = [ \begin{matrix}{M}_{α} & 0 \\ 0 & {M}_{β}\end{matrix} ] \qquad ( 8 )$$

$$K = [ \begin{matrix}{k}_{α} & - {k}_{α} \\ - {k}_{α} & {k}_{α} + {k}_{β}\end{matrix} ] \qquad ( 9 )$$

where,

$${L}_{α} = \frac{{L}_{2} + {L}_{3}}{2} , {L}_{β} = \frac{{L}_{4} + {L}_{5}}{2} \qquad ( 10 )$$

$$\begin{matrix}{M}_{α} = {m}_{1} + {m}_{2} , & {M}_{β} = {m}_{3} + {m}_{4}\end{matrix} \qquad ( 11 )$$

$${k}_{α} = 4 ( {k}_{2} + {k}_{3} ) \qquad ( 12 )$$

$${k}_{β} = {k}_{4} + {k}_{5} \qquad ( 13 )$$

where, k_{α} is the total stiffness of a 2-degree-of-freedom pier column integration, and k_{β} is total stiffness of the 2-degree-of-freedom pile foundation integration.
step 2: constructing an optimization objective function based on the 2-degree-of-freedom dynamical model;
step 2.1: constructing motion equations for a 2-degree-of-freedom system based on the 2-degree-of-freedom model;
the 2-degree-of-freedom system model is shown in FIG. 6. Considering the damping of the bridge pier and the pile foundation, the structure undergoes random vibration under the action of P(t), where y₁ and y₂ represent the 2-degree-of-freedom displacement time history functions relative to the foundation.

Motion equations for the 2-degree-of-freedom dynamical model can be obtained by means of a direct equilibrium method:

$${m}_{α} {\ddot{y}}_{α} + {c}_{α} ( {\dot{y}}_{α} - {\dot{y}}_{β} ) + {k}_{α} ( {y}_{α} - {y}_{β} ) = P ( t ) \qquad ( 14 )$$

$${m}_{β} {\ddot{y}}_{β} + {c}_{β} {\dot{y}}_{β} + {c}_{α} ( {\dot{y}}_{β} - {\dot{y}}_{α} ) + {k}_{β} {y}_{β} + {k}_{α} ( {y}_{β} - {y}_{α} ) = 0$$

where cᵢ is the damping coefficient; yᵢ is the relative displacement of the mass point; \dot{y}ᵢ is the relative velocity of the mass point; ÿᵢ is the relative acceleration of the mass point; P(t) is an inertial force caused by ground motion, and a random excitation, which can be decomposed into the superposition of a series of harmonic components as follows:

$$P ( t ) = {\int }_{- ∞}^{∞} {p}_{0} {e}^{i θ t} d θ \qquad ( 15 )$$

for any frequency component θ, P^{(θ)}(t)=p₀e^{iθt} is a harmonic excitation, resulting displacements y₁^{(θ)}(t) and y₂^{(θ)}(t) are also harmonic variables and can be expressed as follows:

$${y}_{1}^{( θ )} ( t ) = {Y}_{1} {e}^{i θ t} , {y}_{2}^{( θ )} ( t ) = {Y}_{2} {e}^{i θ t} \qquad ( 16 )$$

Substituting P^{(θ)}(t) and equation (17) into equation (15) to obtain

$$- {m}_{α} {θ}^{2} {Y}_{1} + {c}_{α} i θ ( {Y}_{1} - {Y}_{2} ) + {k}_{α} ( {Y}_{1} - {Y}_{2} ) = {p}_{0} \qquad ( 17 )$$

$$- {m}_{β} {θ}^{2} {Y}_{2} + {c}_{β} i θ {Y}_{2} + {c}_{α} i θ ( {Y}_{2} - {Y}_{1} ) + {k}_{β} {Y}_{β} + {k}_{α} ( {Y}_{2} - {Y}_{1} ) = 0$$

solving to obtain amplitudes of y₁(t) and y₂(t):

$$\begin{matrix}{Y}_{1} = & \frac{− {p}_{0} ( {k}_{α} + {k}_{β} − {m}_{β} {θ}^{2} + {c}_{α} θ i + {c}_{β} θ i )}{{k}_{α} {m}_{α} {θ}^{2} − {k}_{α} {k}_{β} + {k}_{α} {m}_{β} {θ}^{2} + {k}_{β} {m}_{α} {θ}^{2} + {c}_{α} {c}_{β} {θ}^{2} − {m}_{α} {m}_{β} {θ}^{4} -} \\ & {k}_{β} {c}_{α} θ i − {k}_{α} {c}_{β} θ i + {m}_{α} {c}_{α} {θ}^{3} i + {m}_{β} {c}_{α} {θ}^{3} i + {m}_{α} {c}_{β} {θ}^{3} i\end{matrix} \qquad ( 18 )$$

$$\begin{matrix}{Y}_{2} = & \frac{− {p}_{0} ( {k}_{α} + {c}_{α} θ i )}{{k}_{α} {m}_{α} {θ}^{2} − {k}_{α} {k}_{β} + {k}_{α} {m}_{β} {θ}^{2} + {k}_{β} {m}_{α} {θ}^{2} + {c}_{α} {c}_{β} {θ}^{2} − {m}_{α} {m}_{β} {θ}^{4} -} \\ & {k}_{β} {c}_{α} θ i − {k}_{α} {c}_{β} θ i + {m}_{α} {c}_{α} {θ}^{3} i + {m}_{β} {c}_{α} {θ}^{3} i + {m}_{α} {c}_{β} {θ}^{3} i\end{matrix} \qquad ( 19 )$$

substituting into equations (16) to obtain y₁^{(θ)}(t) and y₂^{(θ)}(t), and summing over a frequency domain to obtain y₁(t) and y₂(t).
step 2.2: optimizing an objective function;

The optimization should aim to minimize the overall dynamic response of the structure. Key indicators that can reflect the overall dynamic response of the structure include parameters such as the pier bottom bending moment and the main girder displacement. The pier bottom bending moment and the main girder displacement are correlated, and optimization targets thereof are the stiffness ratio between the pile foundation and the bridge pier, as well as the mass ratio between the pile cap and the main girder. Therefore, by optimizing the objective function with parameters such as the pier bottom bending moment and the main girder displacement, a reasonable matching of main girder mass-bridge pier stiffness-pile cap mass-pile foundation stiffness can be achieved, thereby optimizing the design of the pile foundation seismic isolation system. In the seismic design of bridges, the pier bottom bending moment is often the key parameter controlling the design. In this embodiment, the pier bottom bending moment is used as the indicator to evaluate the overall response of the structure. As shown in FIG. 6, the pier bottom bending moment:

$$M ( t ) = {k}_{α} {L}_{α} ( {y}_{1} ( t ) - {y}_{2} ( t ) ) \qquad ( 20 )$$

Similarly, for any frequency component θ,

$${M}^{( θ )} ( t ) = {k}_{α} {L}_{α} ( {y}_{1}^{( θ )} ( t ) - {y}_{2}^{( θ )} ( t ) ) \qquad ( 21 )$$

substitute equations (19) and equations (20) into equation (22) to obtain M^{(θ)}(t), which is expressed in the form of a transfer function H(θ) as:

$$M ( t ) = {\int }_{- ∞}^{∞} H ( θ ) {P}_{0} {e}^{i θ t} d θ \qquad ( 22 )$$

where,

$$H ( θ ) = {k}_{α} {L}_{α} \frac{{k}_{β} - {m}_{β} {θ}^{2} + i {c}_{β} θ}{\begin{matrix}- {k}_{α} {m}_{α} {θ}^{2} + {k}_{α} {k}_{β} - {k}_{α} {m}_{β} {θ}^{2} - {k}_{β} {m}_{α} {θ}^{2} - \\ {c}_{α} {c}_{β} {θ}^{2} + {m}_{α} {m}_{β} {θ}^{4} + \\ i ( {k}_{β} {c}_{α} θ + {k}_{α} {c}_{β} θ - {m}_{α} {c}_{α} {θ}^{3} - {m}_{β} {c}_{α} {θ}^{3} - {m}_{α} {c}_{β} {θ}^{3} )\end{matrix}} \qquad ( 23 )$$

Since seismic motion is a zero-mean random process, M(t) is also a zero-mean random process, when the variance σₘ² of M(t) is minimized, M(t) is also minimized, and according to the definition of the variance, it can be obtained that

$${σ}_{m}^{2} = E [ {\vert M ( t ) \vert}^{2} ] \qquad ( 24 )$$

substituting equation (23) into equation (24) and performing non-dimensionalization to obtain a non-dimensional form I of the variance σₘ²:

$$I = \frac{1}{2 π} {\int }_{- ∞}^{∞} {\vert H ( g ) \vert}^{2} d g \qquad ( 25 )$$

where, g represents a ratio

$$( \frac{θ}{{ω}_{α}} )$$

of a seismic excitation to a structural frequency; and H(g) is the non-dimensional form of the transfer function H(θ):

$$H ( g ) = \frac{( {f}^{2} - {g}^{2} ) + 2 i \frac{{c}_{β}}{{c}_{c β}} gf}{\begin{matrix}( - \frac{1}{μ} {g}^{2} + ( {g}^{2} - {f}^{2} ) ( {g}^{2} - 1 ) + \frac{4 {c}_{α} {c}_{β}}{{c}_{c α} {c}_{c β}} {fg}^{2} ) + \\ i ( 2 \frac{{c}_{α}}{{c}_{c α}} g ( {f}^{2} - \frac{1}{μ} {g}^{2} - {g}^{2} ) + 2 \frac{{c}_{β}}{{c}_{c β}} fg ( 1 - {g}^{2} ) )\end{matrix}} \qquad ( 26 )$$

where,

$$μ = \frac{{m}_{β}}{{m}_{α}} {ω}_{α}^{2} = \frac{{k}_{α}}{{m}_{α}} {ω}_{β}^{2} = \frac{{k}_{β}}{{m}_{β}} f = \frac{{ω}_{β}}{{ω}_{α}} \\ g = \frac{θ}{{ω}_{α}} {c}_{c α} = 2 {m}_{α} {ω}_{β} {c}_{c β} = 2 {m}_{β} {ω}_{β} \frac{{k}_{β}}{{k}_{α}} = μ {f}^{2} \qquad ( 27 )$$

in equation (26), p represents a mass ratio of a pile cap to a main girder equivalent mass point, ω_{α} represents a natural vibration frequency of the main girder and the bridge pier, ω_{β} represents a natural vibration frequency of the pile cap and the pile foundation, f represents a frequency ratio between the pile foundation and the pier column, g represents a frequency ratio between an external load excitation frequency and the pier column, c_{cα} represents critical damping of the bridge pier, and c_{cβ} represents critical damping of the pile foundation.

For the convenience of calculation, equation (25) is organized as:

$$H ( g ) = \frac{{B}_{0} + {igB}_{1} - {g}^{2} {B}_{2}}{{A}_{0} + {igA}_{1} - {g}^{2} {A}_{2} - {ig}^{3} {A}_{3} + {g}^{4} {A}_{4}} \qquad ( 28 )$$

where,

$${B}_{0} = {f}^{2} ; {B}_{1} = 2 \frac{{c}_{β}}{{c}_{c β}} f ; {B}_{2} = 1 ; {A}_{0} = {f}^{2} ; {A}_{1} = 2 \frac{{c}_{α}}{{c}_{c α}} {f}^{2} + 2 \frac{{c}_{β}}{{c}_{c β}} f \\ {A}_{2} = \frac{1}{μ} + {f}^{2} + 1 - \frac{4 {c}_{{α}^{C} β}}{{c}_{c α} {c}_{c β}} f ; {A}_{3} = 2 \frac{1}{μ} \frac{{c}_{α}}{{c}_{c α}} + 2 \frac{{c}_{α}}{{c}_{c α}} + 2 \frac{{c}_{β}}{{c}_{c β}} f ; {A}_{4} = 1 \qquad ( 29 )$$

equation (28) is substituted into equation (25) and then integrated, and let

$${ξ}_{1} = \frac{{c}_{1}}{{c}_{c α}} and {ξ}_{2} = \frac{{c}_{2}}{{c}_{c β}} ,$$

and a formula expression for the non-dimensional form I of the variance σ² is obtained, which is the optimization objective function:

$$\begin{matrix}I = \frac{[ \begin{matrix}- {A}_{0} {A}_{1} {A}_{4} {B}_{2}^{2} - {A}_{0} {A}_{3} {A}_{4} ( {B}_{1}^{2} - 2 {B}_{0} {B}_{2} ) + \\ {A}_{4} {B}_{0}^{2} ( {A}_{1} {A}_{4} - {A}_{2} {A}_{3} )\end{matrix} ]}{2 {A}_{0} {A}_{4} ( {A}_{0} {A}_{3}^{2} + {A}_{1}^{2} {A}_{4} - {A}_{1} {A}_{2} {A}_{3} )} \\ = \frac{M ( μ , f , {ξ}_{1} , {ξ}_{2} )}{M ( μ , f , {ξ}_{1} , {ξ}_{2} )}\end{matrix} \qquad ( 30 )$$

Step 3: parameter optimization

For equation (30), since the damping ratios ξ₁ and ξ₂ of a concrete structure can be taken as 0.05, I is only related to the frequency ratio f and the mass ratio μ. A three-dimensional graph thereof can be plotted, as shown in FIG. 7. From the three-dimensional graph of I(f, μ), it can be seen that for a constant mass ratio μ, the variance decreases first and then increases as the frequency ratio f increases. Therefore, for a constant mass ratio, there is a minimum value of the variance, and the corresponding frequency ratio at this minimum value is the optimal frequency ratio. By optimizing a variance equation, the optimal frequency ratio f corresponding to each mass ratio μ can be determined.

For a continuous rigid-frame bridge, since the ranges of variation for μ and f are not large and the velocity requirement is not high, the optimal frequency ratio for the pile foundation and the bridge pier can be determined by means of an enumeration method. The non-dimensional form I of the variance σ² has two variables μ and f. By treating f as a function of μ, the problem is transformed into a two-dimensional optimization problem. On this basis, a relational expression for the optimal frequency ratio and the mass ratio can be determined.

The optimization process using the enumeration method is as follows:
(1) determining the mass ratio μᵢ;
(2) traversing the frequency ratio f;
(3) calculating the variance I(f, μ);
(4) minimizing the variance I;
(5) obtaining the corresponding I(fᵢ, μᵢ);
(6) updating μᵢ=μᵢ+Δμ; and simultaneously obtaining the relationship f(u) between the optimal frequency ratio and the mass ratio.

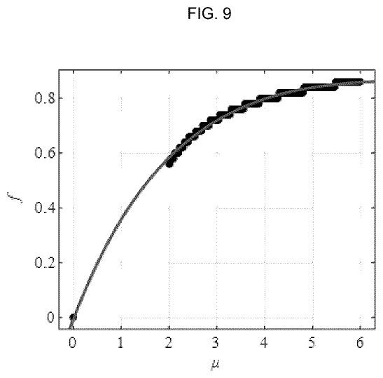

Through the optimization process mentioned above, the optimal frequency ratio f corresponding to each mass ratio μ when the variance is minimized is determined and plotted in FIG. 9. Through curve fitting based on the above data, an explicit expression for the optimal frequency ratio f is obtained.

$$f = 1.108 {e}^{- 0.027 \; 55 μ} - 1.116 {e}^{- 0.436 \; 8 μ} \qquad ( 31 )$$

A correlation coefficient of a fitting curve R2=0.993, indicates a high correlation between the two. This represents a calculation formula for the optimal frequency ratio of the pile foundation and the bridge pier with the pier bottom bending moment as an optimization objective; after the optimal frequency ratio f is obtained, the total stiffness correction value k_{β1} for the 2-degree-of-freedom pile foundation integration is calculated using the following formula:

$${k}_{β 1} = \frac{{m}_{β} {k}_{α} {f}^{2}}{{m}_{α}} . \qquad ( 32 )$$

Step 4: calculation of the pile diameter;

calculating the ratio of masses m_{β} and m_{α} according to equation (27) to obtain μ=0.66, substituting the mass ratio μ into equation (31) to obtain the optimal frequency ratio f of the pile foundation, substituting parameters into equation (32) to obtain the total stiffness correction value k_{β1} of the 2-degree-of-freedom pile foundation integration, calculating corrected bridge pier and pile foundation stiffness k₄₁ and k₅₁, back-calculating I₄₁ and I₅₁ according to equation (1), and inferring the corresponding pile foundation layout and the optimal diameter based on I₄₁ and I₅₁. Calculation formulas for k₄₁ and k₅₁ are as follows:

$${k}_{41} = \frac{{k}_{β 1} {k}_{4}}{{k}_{β}} \qquad ( 33 )$$

$${k}_{51} = \frac{{k}_{β 1} {k}_{5}}{{k}_{β}}$$

The above embodiments only express specific implementations of the present application, and are described in more detail, but are not to be construed as a limitation to the scope of protection of the present application. It is to be noted that several variations and modifications can also be made by those of ordinary skill in the art without departing from the concepts the technical solutions of the present application, which all fall within the scope of protection of the present application.

What is claimed is:

1. A tuned damping method for seismic isolation of pile foundations in a deep-water long-span continuous rigid frame bridge, comprising the following steps:
step 1: simplifying a deep-water long-span continuous rigid frame bridge model into a 2-degree-of-freedom dynamical model;
step 2: constructing an optimization objective function based on the 2-degree-of-freedom dynamical model;
step 3: performing parameter optimization based on the optimization objective function to obtain an optimal frequency ratio f, and based on the optimal frequency ratio f to calculate a total stiffness correction value k_{β1} of a 2-degree-of-freedom pile foundation integration;
step 4: calculating corrected equivalent moments of inertia I₄₁ and I₅₁ for a pile foundation based on the total stiffness correction value k_{β1} of the 2-degree-of-freedom pile foundation integration, and inferring a corresponding pile foundation layout and an optimal diameter based on the corrected equivalent moments of inertia I₄₁ and I₅₁.

2. A tuned damping method for seismic isolation of pile foundations in a deep-water long-span continuous rigid frame bridge according to claim 1, wherein the step 1 comprises:
step 1.1: simplifying the deep-water long-span continuous rigid frame bridge model into a 3-degree-of-freedom dynamical model;
step 1.2: simplifying the 3-degree-of-freedom dynamical model into the 2-degree-of-freedom dynamical model.

3. A tuned damping method for seismic isolation of pile foundations in a deep-water long-span continuous rigid frame bridge according to claim 2, wherein the step 1.1 comprises:
letting anti-thrust stiffness of a pile group in the deep-water long-span continuous rigid frame bridge model be kₚ, and solving by means of a displacement method or finite element simulation method to obtain an equivalent moment of inertia Iₚ:
$${I}_{p} = \frac{{k}_{p} {L}_{p}^{3}}{12 {E}_{p}} \qquad ( 1 )$$
where, Lₚ is a pile foundation length, and Eₚ is the elastic modulus of pile foundation;
basing on the equivalent moment of inertia Iₚ to simplify the deep-water long-span continuous rigid frame bridge model into the 3-degree-of-freedom dynamical model, with parameters comprising a pier column stiffness, a pile foundation stiffness, and a mass parameters, and specific formulas for the parameters are as follows:
the pier column stiffness comprises a pier column longitudinal stiffness k₂ and a pile column transverse stiffness k₃:
$$\begin{matrix}{k}_{2} = \frac{3 {E}_{2} {I}_{2}}{{L}_{2}^{3}} + Δ k & {k}_{3} = \frac{3 {E}_{3} {I}_{3}}{{L}_{3}^{3}} + Δ k\end{matrix} \qquad ( 2 )$$
the pile foundation stiffness comprises a pier foundation longitudinal stiffness k₄ and a pile foundation transverse stiffness k₅, which can be calculated using a force method or a finite element method;
main girder bending restraint correction term:
$$Δ k = \frac{6 {E}_{2} {I}_{2} ( 6 {E}_{1} {I}_{1} {I}_{2} + {E}_{2} {I}_{2} {L}_{1} )}{{L}_{2}^{3} ( 3 {E}_{1} {I}_{1} {L}_{2} + 2 {E}_{2} {I}_{2} {L}_{1} )} - \frac{3 {E}_{2} {I}_{2}}{{L}^{3}} \qquad ( 3 )$$
the mass parameters comprises a pier top mass and a pier bottom mass:
the pier top mass:
$$\begin{matrix}{m}_{1} = \frac{{m}_{b}}{2} + \frac{{m}_{p 2}}{2} & {m}_{2} = \frac{{m}_{b}}{2} + \frac{{m}_{p 3}}{2}\end{matrix} \qquad ( 4 )$$
the pier bottom mass:
$${m}_{3} = \frac{{m}_{c}}{2} + \frac{{m}_{p 2}}{2} + \frac{{m}_{p 4}}{2} \qquad ( 5 )$$
$${m}_{4} = \frac{{m}_{c}}{2} + \frac{{m}_{p 3}}{2} + \frac{{m}_{p 5}}{2}$$
where, I₂ and I₃ are moments of inertia of cross-sections of pier columns, I₄ and I₅ are calculated according to equation (1), m₁ is the sum of main girder mass and pier column mass on a left span of a bridge, m₂ is the sum of main girder mass and pier column mass on a right span of the bridge, m₃ is the sum of pier column mass and pile foundation mass on the left span of the bridge, m₄ is the sum of pier column mass and pile foundation mass on the right span of the bridge, m_{b} is total mass of a main girder, mₚ₂ and mₚ₃ are masses of bridge piers respectively, mₚ₄ and mₚ₅ are masses of pile foundations respectively, L₁ is the length of the main girder, L₂ and L₃ are the lengths of the bridge piers, L₄ and L₅ are the lengths of the pile foundations, E₁ is the elastic modulus of the main girder, E₂ and E₃ are the elastic modulus of the bridge piers, and L₄ and L₅ are the elastic modulus of the pile foundations;
a mass matrix M and a stiffness matrix K of the 3-degree-of-freedom dynamical model are:
$$M = [ \begin{matrix}{m}_{1} + {m}_{2} & 0 & 0 \\ 0 & {m}_{3} & 0 \\ 0 & 0 & {m}_{4}\end{matrix} ] \qquad ( 6 )$$
$$K = [ \begin{matrix}{k}_{2} + {k}_{3} + 2 Δ k & − {k}_{2} − Δ k & − {k}_{3} − Δ k \\ − {k}_{2} − Δ k & {k}_{4} + {k}_{2} + Δ k & 0 \\ − {k}_{3} − Δ k & 0 & {k}_{5} + {k}_{3} + Δ k\end{matrix} ] . \qquad ( 7 )$$

4. A tuned damping method for seismic isolation of pile foundations in a deep-water long-span continuous rigid frame bridge according to claim 2, where in the step 1.2 comprises: assuming the deep-water long-span continuous rigid frame bridge model to be a symmetric structure, that is: E₂I₂=E₃I₃, E₄I₄=E₅I₅, m₁=m₂, m₃=m₄, L₂=L₃, and L₄=L₅, and further simplifying the 3-degree-of-freedom dynamical model into the 2-degree-of-freedom dynamical model, with the mass matrix M and stiffness matrix K thereof as shown in equations (8) and (9) respectively:
$$M = [ \begin{matrix}{M}_{α} & 0 \\ 0 & {M}_{β}\end{matrix} ] \qquad ( 8 )$$
$$K = [ \begin{matrix}{k}_{α} & - {k}_{α} \\ - {k}_{α} & {k}_{α} + {k}_{β}\end{matrix} ] \qquad ( 9 )$$
where,
$$\begin{matrix}{L}_{α} = \frac{{L}_{2} + {L}_{3}}{2} , & {L}_{β} = \frac{{L}_{4} + {L}_{5}}{2}\end{matrix} \qquad ( 10 )$$
$$\begin{matrix}{M}_{α} = {m}_{1} + {m}_{2} , & {M}_{β} = {m}_{3} + {m}_{4}\end{matrix} \qquad ( 11 )$$
$${k}_{α} = 4 ( {k}_{2} + {k}_{3} ) \qquad ( 12 )$$
$${k}_{β} = {k}_{4} + {k}_{5} \qquad ( 13 )$$
Where, k_{α} is total stiffness of a 2-degree-of-freedom pier column integration, and k_{β} is total stiffness of the 2-degree-of-freedom pile foundation integration.

5. A tuned damping method for seismic isolation of pile foundations in a deep-water long-span continuous rigid frame bridge according to claim 1, wherein the step 2 comprises:
step 2.1: constructing motion equations for a 2-degree-of-freedom system based on the 2-degree-of-freedom dynamical model;
step 2.2: constructing an optimization objective function based on the motion equations for the 2-degree-of-freedom system.

6. A tuned damping method for seismic isolation of pile foundations in a deep-water long-span continuous rigid frame bridge according to claim 5, wherein the step 2.1 comprises: considering damping of the bridge piers and the pile foundations, and enabling the bridge structure to undergo random vibration under the action of P(t), wherein y₁ and y₂ represent 2-degree-of-freedom displacement time history functions relative to a foundation, and motion equations for the 2-degree-of-freedom dynamical model can be obtained by means of a direct equilibrium method as follows:
$${m}_{α} {\ddot{y}}_{α} + {c}_{α} ( {\dot{y}}_{α} - {\dot{y}}_{β} ) + {k}_{α} ( {y}_{α} - {y}_{β} ) = P ( t ) \qquad ( 14 )$$
$${m}_{β} {\ddot{y}}_{β} + {c}_{β} {\dot{y}}_{β} + {c}_{α} ( {\dot{y}}_{β} - {\dot{y}}_{α} ) + {k}_{β} {y}_{β} + {k}_{α} ( {y}_{β} - {y}_{α} ) = 0$$
where cᵢ is a damping coefficient; yᵢ is the relative displacement of a mass point; \dot{y}ᵢ is the relative velocity of the mass point; ÿᵢ is a relative acceleration of the mass point; P(t) is an inertial force caused by ground motion, and P(t) is a random excitation which can be decomposed into the superposition of a series of harmonic components as follows:
$$P ( t ) = {\int }_{- ∞}^{∞} {p}_{0} {e}^{i θ t} d θ \qquad ( 15 )$$
for any frequency component θ, P^{(θ)}(t)=p₀e^{iθt} is a harmonic excitation, and resulting displacements y₁^{(θ)}(t) and y₂^{(θ)} (t) are also harmonic variables and can be expressed as follows:
$${y}_{1}^{( θ )} ( t ) = {Y}_{1} {e}^{i θ t} , {y}_{2}^{( θ )} ( t ) = {Y}_{2} {e}^{i θ t} \qquad ( 16 )$$
substituting P^{(θ)}(t) and equation (16) into equation (14) to obtain
$$- {m}_{α} {θ}^{2} {Y}_{1} + {c}_{α} i θ ( {Y}_{1} - {Y}_{2} ) + {k}_{α} ( {Y}_{1} - {Y}_{2} ) = {p}_{0} \qquad ( 17 )$$
$$- {m}_{β} {θ}^{2} {Y}_{2} + {c}_{β} i θ {Y}_{2} + {c}_{α} i θ ( {Y}_{2} - {Y}_{1} ) + {k}_{β} {Y}_{β} + {k}_{α} ( {Y}_{2} - {Y}_{1} ) = 0$$
solving to obtain amplitudes of y₁(t) and y₂(t):
$$\begin{matrix}{Y}_{1} = & \frac{− {p}_{0} ( {k}_{α} + {k}_{β} − {m}_{β} {θ}^{2} + {c}_{α} θ i + {c}_{β} θ i )}{{k}_{α} {m}_{α} {θ}^{2} − {k}_{α} {k}_{β} + {k}_{α} {m}_{β} {θ}^{2} + {k}_{β} {m}_{α} {θ}^{2} + {c}_{α} {c}_{β} {θ}^{2} − {m}_{α} {m}_{β} {θ}^{4} -} \\ & {k}_{β} {c}_{α} θ i − {k}_{α} {c}_{β} θ i + {m}_{α} {c}_{α} {θ}^{3} i + {m}_{β} {c}_{α} {θ}^{3} i + {m}_{α} {c}_{β} {θ}^{3} i\end{matrix} \qquad ( 18 )$$
$$\begin{matrix}{Y}_{2} = & \frac{− {p}_{0} ( {k}_{α} + {c}_{α} θ i )}{{k}_{α} {m}_{α} {θ}^{2} − {k}_{α} {k}_{β} + {k}_{α} {m}_{β} {θ}^{2} + {k}_{β} {m}_{α} {θ}^{2} + {c}_{α} {c}_{β} {θ}^{2} − {m}_{α} {m}_{β} {θ}^{4} -} \\ & {k}_{β} {c}_{α} θ i − {k}_{α} {c}_{β} θ i + {m}_{α} {c}_{α} {θ}^{3} i + {m}_{β} {c}_{α} {θ}^{3} i + {m}_{α} {c}_{β} {θ}^{3} i\end{matrix} \qquad ( 19 )$$
substituting into equations (16) to obtain y₁^{(θ)}(t) and y₂^{(θ)}(t), and summing y₁^{(θ)}(t) and y₂^{(θ)}(t) over a frequency domain to obtain y₁(t) and y₂(t).

7. A tuned damping method for seismic isolation of pile foundations in a deep-water long-span continuous rigid frame bridge according to claim 6, where in the step 2.2 comprises: letting a pier bottom bending moment as an indicator to evaluate an overall structural response:
$$M ( t ) = {k}_{α} {L}_{α} ( {y}_{1} ( t ) - {y}_{2} ( t ) ) \qquad ( 20 )$$
for any frequency component θ,
$${M}^{( θ )} ( t ) = {k}_{α} {L}_{α} ( {y}_{1}^{( θ )} ( t ) - {y}_{2}^{( θ )} ( t ) ) \qquad ( 21 )$$
substituting equations (18) and (19) into equation (21) to obtain M^{(θ)}(t), and expressing M^{(θ)}(t) in the form of a transfer function H(θ) as follows:
$$M ( t ) = {\int }_{- ∞}^{∞} H ( θ ) {P}_{0} {e}^{i θ t} d θ \qquad ( 22 )$$
where,
$$H ( θ ) = {k}_{α} {L}_{α} \frac{{k}_{β} - {m}_{β} {θ}^{2} + {ic}_{β} θ}{\begin{matrix}- {k}_{α} {m}_{α} {θ}^{2} + {k}_{α} {k}_{β} - {k}_{α} {m}_{β} {θ}^{2} - {k}_{β} {m}_{α} {θ}^{2} - {c}_{α} {c}_{β} {θ}^{2} + {m}_{α} {m}_{β} {θ}^{4} + \\ i ( {k}_{β} {c}_{α} θ + {k}_{α} {c}_{β} θ - {m}_{α} {c}_{α} {θ}^{3} - {m}_{β} {c}_{α} {θ}^{3} - {m}_{α} {c}_{β} {θ}^{3} )\end{matrix}} \qquad ( 23 )$$
when a variance σₘ² of M(t) is minimized, M(t) is also minimized, and let the variance σₘ² be:
$${σ}_{m}^{2} = E [ {\vert M ( t ) \vert}^{2} ] \qquad ( 24 )$$
substituting equation (23) into equation (24) and performing non-dimensionalization to obtain a non-dimensional form I of the variance σₘ²:
$$I = \frac{1}{2 π} {\int }_{- ∞}^{∞} {\vert H ( g ) \vert}^{2} d g \qquad ( 25 )$$
where, g represents a ratio
$$( \frac{θ}{{ω}_{α}} )$$
of a seismic excitation to a structural frequency; and H(g) is the non-dimensional form of the transfer function H(θ):
$$H ( g ) = \frac{( {f}^{2} - {g}^{2} ) + 2 i \frac{{c}_{β}}{{c}_{c β}} gf}{\begin{matrix}( - \frac{1}{μ} {g}^{2} + ( {g}^{2} - {f}^{2} ) ( {g}^{2} - 1 ) + \frac{4 {c}_{α} {c}_{β}}{{c}_{c α} {c}_{c β}} {fg}^{2} ) + \\ i ( 2 \frac{{c}_{α}}{{c}_{c α}} g ( {f}^{2} - \frac{1}{μ} {g}^{2} - {g}^{2} ) + 2 \frac{{c}_{β}}{{c}_{c β}} fg ( 1 - {g}^{2} ) )\end{matrix}} \qquad ( 26 )$$
where,
$$μ = \frac{{m}_{β}}{{m}_{α}} {ω}_{α}^{2} = \frac{{k}_{α}}{{m}_{α}} {ω}_{β}^{2} = \frac{{k}_{β}}{{m}_{β}} f = \frac{{ω}_{β}}{{ω}_{α}} \\ g = \frac{θ}{{ω}_{α}} {c}_{c α} = 2 {m}_{α} {ω}_{β} {c}_{c β} = 2 {m}_{β} {ω}_{β} \frac{{k}_{β}}{{k}_{α}} = μ {f}^{2} \qquad ( 27 )$$
in equation (26), μ represents a mass ratio of a pile cap to a main girder equivalent mass point, ω_{α} represents a natural vibration frequency of the main girder and the bridge pier, ω_{β} represents a natural vibration frequency of the pile cap and the pile foundation, f represents a frequency ratio between the pile foundation and the pier column, g represents a frequency ratio between an external load excitation and the pier column, c_{cα} represents critical damping of the bridge pier, and c_{cβ} represents critical damping of the pile foundation;
organizing equation (25) as:
$$H ( g ) = \frac{{B}_{0} + {igB}_{1} - {g}^{2} {B}_{2}}{{A}_{0} + {igA}_{1} - {g}^{2} {A}_{2} - {ig}^{3} {A}_{3} + {g}^{4} {A}_{4}} \qquad ( 28 )$$
where,
$${B}_{0} = {f}^{2} ; \\ {B}_{1} = 2 \frac{{c}_{β}}{{c}_{c β}} f ; \\ {B}_{2} = 1 ; \\ {A}_{0} = {f}^{2} ; \\ {A}_{1} = 2 \frac{{c}_{α}}{{c}_{c α}} {f}^{2} + 2 \frac{{c}_{β}}{{c}_{c β}} f {A}_{2} = \frac{1}{μ} + {f}^{2} + 1 - \frac{4 {c}_{α} {c}_{β}}{{c}_{c α} {c}_{c β}} f ; \\ {A}_{3} = 2 \frac{1}{μ} \frac{{c}_{α}}{{c}_{c α}} + 2 \frac{{c}_{α}}{{c}_{c α}} + 2 \frac{c β}{{c}_{c β}} f ; \\ {A}_{4} = 1 \qquad ( 29 )$$
substituting equation (28) into equation (25) for integration, letting
$${ξ}_{1} = \frac{{c}_{1}}{{c}_{c α}} and {ξ}_{2} = \frac{{c}_{2}}{{c}_{c β}} ,$$
and obtaining the non-dimensional form I of the variance σ², which serves as the optimization objective function:
$$I = \frac{[ - {A}_{0} {A}_{1} {A}_{4} {B}_{2}^{2} - {A}_{0} {A}_{3} {A}_{4} ( {B}_{1}^{2} - 2 {B}_{0} {B}_{2} ) + {A}_{4} {B}_{0}^{2} ( {A}_{1} {A}_{4} - {A}_{2} {A}_{3} ) ]}{2 {A}_{0} {A}_{4} ( {A}_{0} {A}_{3}^{2} + {A}_{1}^{2} {A}_{4} - {A}_{1} {A}_{2} {A}_{3} )} = \frac{M ( μ , f , {ξ}_{1} , {ξ}_{2} )}{N ( μ , f , {ξ}_{1} , {ξ}_{2} )} . \qquad ( 30 )$$

8. A tuned damping method for seismic isolation of pile foundations in a deep-water long-span continuous rigid frame bridge according to claim 1, where in the step 3 comprises: optimizing the variance by using an enumeration method, finding an optimal frequency ratio f corresponding to each mass ratio μ when the variance is minimized, and performing curve fitting to obtain an explicit expression for the optimal frequency ratio f:
$$f = 1.108 {e}^{- 0.02755 μ} - 1.116 {e}^{- 0.4368 μ} \qquad ( 31 )$$
based on the optimal frequency ratio f, calculating a total stiffness correction value k_{β1} of a 2-degree-of-freedom pile foundation integration:
$${k}_{β 1} = \frac{{m}_{β} {k}_{α} {f}^{2}}{{m}_{α}} . \qquad ( 32 )$$

9. A tuned damping method for seismic isolation of pile foundations in a deep-water long-span continuous rigid frame bridge according to claim 8, where in the optimization process using the enumeration method comprises the following steps:
(1) determining the mass ratio μ;
(2) traversing the frequency ratio f;
(3) calculating the variance I(f, μ);
(4) minimizing the variance I;
(5) obtaining the corresponding I(fᵢ, μᵢ); and
(6) updating μᵢ=μᵢ+Δμ; and simultaneously obtaining the relationship f(u) between the optimal frequency ratio and the mass ratio.

10. A tuned damping method for seismic isolation of pile foundations in a deep-water long-span continuous rigid frame bridge according to claim 1, where in the step 4 comprises:
calculating the mass ratio μ according to equation (27), substituting the mass ratio μ into equation (31) to obtain an optimal frequency ratio f of the pile foundation, according to equation (32) to obtain the total stiffness correction value k_{β1} for the 2-degree-of-freedom pile foundation integration, calculating corrected bridge pier and pile foundation stiffness k₄₁ and k₅₁, back-calculating the equivalent moments of inertia I₄₁ and I₅₁ of the pile foundation according to equation (1), and based on the equivalent moments of inertia I₄₁ and I₅₁, inferring the corresponding pile foundation layout and the optimal diameter, where calculation formulas for k₄₁ and k₅₁ are as follows:
$$\begin{matrix}{k}_{41} = \frac{{k}_{β 1} {k}_{4}}{{k}_{β}} \\ {k}_{51} = \frac{{k}_{β 1} {k}_{5}}{{k}_{β}}\end{matrix} . \qquad ( 33 )$$
